(19) United States
(12) Patent Application Publication
(10) Pub. No.: US 2002/0140324 A1
(43) Pub. Date: Oct. 3, 2002

(54) Leveling device and method for laboratory incubators

(75) Inventor: Charles G. Butts, Weavervill, NC (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(73) Assignee: Revco Technologies, Inc.

(21) Appl. No.: 09/819,768

(22) Filed: Mar. 29, 2001

(51) Int. Cl. B01L 9/02; A61C 19/02

(52) U.S. Cl. 312/209

(57) ABSTRACT

A laboratory incubator includes a cabinet having four walls, a top wall and lower wall. The cabinet encloses the interior of an incubation chamber which is accessible through a door which is provided on one side wall. In addition, the laboratory incubator has a leveling indicator mounted to the top wall of the cabinet and/or upon an interior shelf located within the incubation chamber of the cabinet. The laboratory incubator also provides a set of adjustable feet mounted to the cabinet which support the cabinet.

### FIELD OF THE INVENTION

The present invention relates generally to leveling devices. More particularly, the present invention relates leveling devices for insuring a laboratory incubator is level prior to use.

### BACKGROUND OF THE INVENTION

Present practice in tissue and cell culture research laboratories requires the operator or technician to level the laboratory incubator cabinet in order to insure that cell growth occurs evenly in the cell plate. Leveling the incubator cabinet provides for the even distribution of media which allows for uniform cell growth in the media plate. The internal contents of a typical incubator cabinet includes shelving, and cell plates are placed upon that shelving with cells suspended in solution or media that provides nutrients for growth. The cells grow and multiply in layers therefore it is essential that the media be evenly distributed throughout the cell plate. If the incubator cabinet is not leveled prior to operation, the media will be distributed unevenly in the cell plate, causing the cells to congregate at the low side of the plate. This occurrence in turn makes it very difficult for the researcher to dissect the individual cells.

Conventionally, in order to insure that the incubator cabinet is level, the operator must first locate a separate bubble-type level tool and carefully place the incubator into position. The incubator cabinet must next be leveled left to right and front to back by placing the level at various locations on the upper, plane surface of the incubator cabinet. The leveling is achieved by utilizing the adjustable feet of the cabinet as a means of correction. If the incubator is one which utilizes a water jacket, the incubator must be leveled twice, upon installation and after the water jacket has been filled, because the filling of the water jacket may cause deflection due to the added weight of the water and therefore the incubator must leveled a second time.

Some disadvantages of the above described approach are that first, a bubble-type level is not readily available in most research laboratories and second, the placement of a bubble style level on the upper, plane surface of the incubator cabinet does not guarantee that the shelving located within the cabinet is in fact level. The aforementioned occurrence may result from defects in the manufacturing process of the cabinet or the differing construction and manufacturing tolerances of the various incubator cabinets. Thus, the cabinet may be leveled yet the shelving within the cabinet is not, causing the media to be distributed unevenly, resulting in the uneven growth of cells.

Accordingly, it is desirable to provide a leveling device that helps insure the contents of the incubator cabinet are situated at 180 degrees with respect to horizontal. Similarly, there is a need for a level device that enables the operator to observe whether the incubator is level with respect to front to back and left to right, without the need for a separate level tool.

### SUMMARY OF THE INVENTION

The foregoing needs are met, to a great extent, by the present invention where, in one aspect, a laboratory incubator is provided having a cabinet with four side walls, a top wall and a lower wall. The cabinet encloses the interior of an incubation chamber which is accessible through the door which is provided on one side wall. In addition, the laboratory incubator has a leveling indicator mounted to the top wall of the cabinet. The laboratory incubator also provides a set of adjustable feet mounted to the cabinet which support the cabinet.

In another aspect, the invention provides a leveling indicator mounted upon the interior shelf of the laboratory incubator.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 shows a front elevational view of an incubator cabinet with a bullseye level indicator installed on the upper surface of the top wall of the cabinet.

FIG. 2 provides a top view of the incubator cabinet having the bullseye level indicator shown in FIG. 1 mounted thereon the upper surface.

FIG. 3 shows a perspective view of the incubator cabinet and interior shelf with a bullseye level indicator mounted on the interior shelf.

FIG. 4 provides a top view of the bullseye level and interior shelf.

FIG. 5 is a perspective view of an alternate embodiment with a bullseye level indicator mounted on a control module.

### DETAILED DESCRIPTION OF PREFERRED EMBODIMENTS OF THE INVENTION

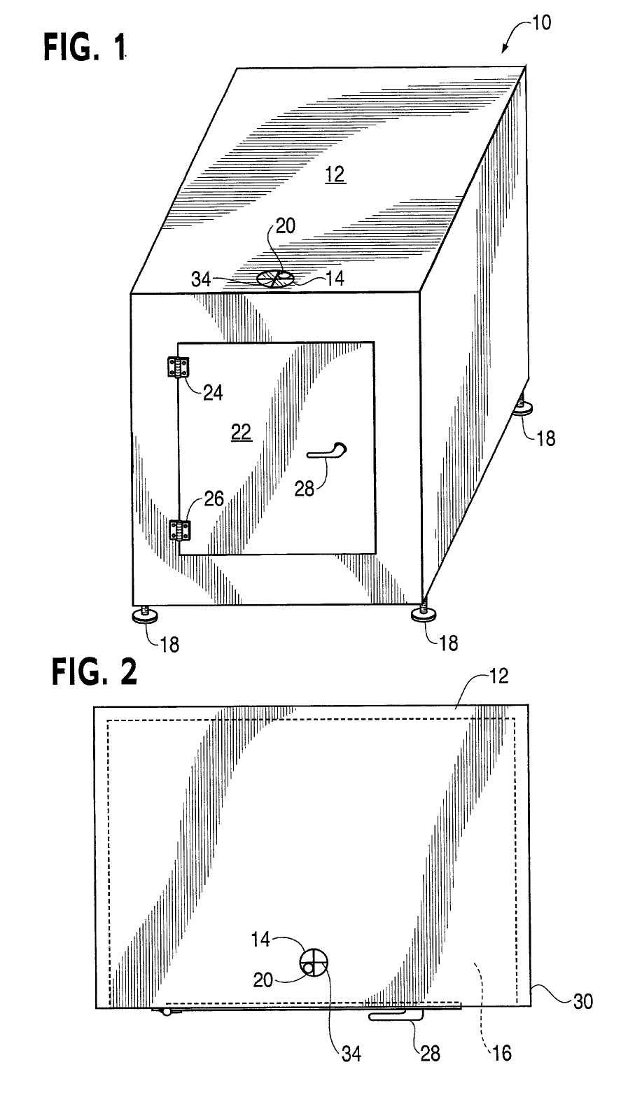

Referring now to the figures wherein like reference numerals indicate like elements, FIGS. 1-4 illustrate the presently preferred embodiment of an incubator cabinet 10 with the leveling indicator of the present invention. While in the embodiment depicted the cabinet is a cell culture incubator, it should be understood that the present invention is not limited in its application to cell culture incubators, and may be used, for example, with refrigerators, ovens, storage cabinets and the like.

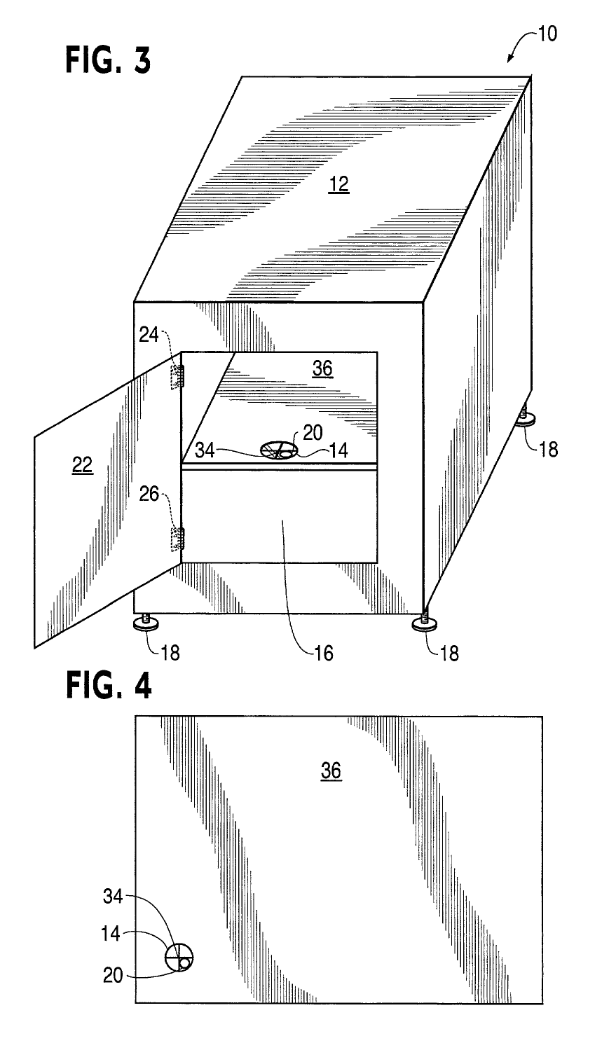

FIG. 1 illustrates a cell culture incubator cabinet 10 in accordance with the present invention and generally including a top wall 12, bullseye level indicator 14, interior controlled atmosphere chamber 16 (see FIG. 3) and four adjustment feet 18 located near the comers of the cabinet 10. The bullseye level indicator 14 contains a fluid having a bubble 20 and is mechanically installed into the top surface of the top wall 12 of the incubator 10, providing the operator with an easy method for insuring that the cabinet 10 is level prior to its use. Chamber 16 is accessed through an insulated door 22. The door 22 is attached to the cabinet 10 by a pair of hinges 24, 26. The hinges 24, 26, may be alternatively attached to the left or right side of the cabinet 10, depending on which direction it is desired to swing the door 22. The door 22 further includes a latch assembly having a twist latch 28 fastened to the door 22. The latch 28 bears against the cabinet frame 30 when in the latched position to seal the door 22 against the frame 30 (see FIG. 2). FIG. 1 also illustrates that the cabinet 10 is supported by the four adjustment feet 18 with which the operator may use as a means for correction when leveling the incubator cabinet 10.

FIG. 2 illustrates the bullseye leveling indicator 14 of the present invention as it is mechanically installed in the incubator top wall 12 of the incubator cabinet 10. The leveling indicator 14 encompasses a bullseye leveling arrangement including a fluid filled glass enclosure having a domed inner surface and a bubble 20 that is suspended in the fluid. The bubble 20 remains at the top of the domed surface, and cross hairs 34 and various other markings may be printed on the leveling indicator 14. By comparing the location of the bubble 20 with the cross hairs 34, the operator can determine whether the object to which the leveling indicator 14 is attached is in fact level. The above mentioned characteristics of the level 14 enable the operator to level the cabinet 10 with respect to front to back and left to right utilizing the adjustment feet 18 It is preferred to install the leveling indicator 14 near the front edge of the top surface of the top wall 12 as shown to facilitate viewing the level 14 from the front of the incubator 10. Because the inner surface of the leveling indicator 14 is domed, the bubble 20 shows deviation from level in any plane angle. Thus, it is preferable to a conventional separate planar level, which must be placed on the top surface manually at many different angles.

Referring now to FIG. 3, the interior, controlled, atmosphere chamber 16 of the incubator cabinet 10 is shown in greater detail. FIG. 3 illustrates an alternative, preferred embodiment of the present invention where the bullseye level indicator 14 is mechanically installed into the interior shelf 36 of the controlled atmosphere chamber 16 of the incubator cabinet 10. The leveling indicator 14 encompasses a fluid filled glass enclosure having a domed inner surface and a bubble 20 that is suspended in the fluid. The bubble 20 remains at the top of the domed surface, and cross hairs 34 and various other markings may be printed on the leveling indicator 14. By comparing the location of the bubble indicator 20 with the cross hairs 34, the operator can determine whether the shelf 36 upon which the cell plates are placed is in fact level. By installing the leveling indicator 14 into the interior shelf 36, the incubator cabinet 10 may be leveled with respect to the exact surface upon which the cell plates are located. This is achieved by using the adjustment feet 18 to modify the placement of the incubator cabinet 10. The placement of the indicator 14 into the interior shelf 36 in this embodiment enables the operator to provide a level condition of the shelf 36 itself. As a result, the negative effects on cell growth that result from cabinet defects due to the manufacturing process of the cabinet or varying construction and manufacturing tolerances are minimized.

FIG. 4 is a top view of the interior shelf 36 with the leveling indicator 14 inserted. As shown in FIG. 4, the interior shelf 36 is removable and the leveling indicator 14 is placed in the front, left corner of the shelf 36. The leveling indicator 14 may be inserted into any area on the shelf 36; however, in the preferred embodiment of the present invention, the leveling indicator 14 is inserted into the front portion of the shelf 36, adjacent to the door 22 of the incubator cabinet 10. Placement of the leveling indicator 14 into the front region of the shelf 36 enables the operator of the incubator cabinet 10 to view the leveling indicator 14 clearly and easily and in addition, the front location minimizes the likelihood that the leveling indicator 14 will obstruct the placement of cell plates on the shelf 36. Also, placing the leveling indicator 14 near the open area of the door facilitates viewing the indicator 14 without fully opening the door. However, placement of the leveling indicator 14 is not limited to the front region of the shelf 36.

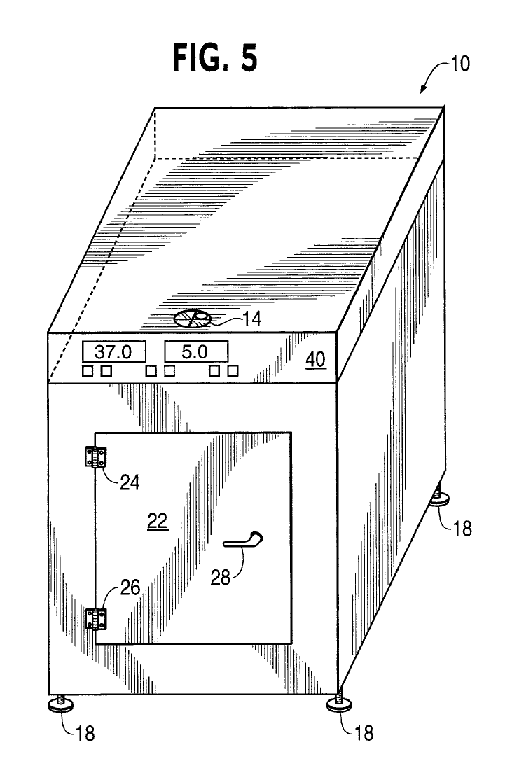

FIG. 5 shows an alternate embodiment where an indicator 14 is mounted to a control module portion 40 of the cabinet 10.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A laboratory incubator comprising:
a cabinet having four side walls, a top wall and a bottom wall, said cabinet enclosing an interior incubating chamber;
a leveling indicator mounted on said top wall of said cabinet;
a door on one side wall to allow access to said chamber; and
a plurality of feet mounted to said cabinet for support of said cabinet.

2. A laboratory incubator according to claim 1, wherein said interior incubating chamber further comprises removably mounted interior shelving.

3. A laboratory incubator according to claim 1, wherein said leveling indicator indicates deviations from level around 360 degrees.

4. A laboratory incubator according to claim 3, wherein said leveling indicator is a bullseye type level.

5. A laboratory incubator according to claim 1, wherein said feet are independently adjustable to adjust the level of said cabinet.

6. A laboratory incubator comprising:
a cabinet having four side walls, a top wall and a bottom wall, said cabinet enclosing an interior incubating chamber;
a door in one side wall to allow access to said chamber;
an interior shelf removably mounted within said chamber and accessible through said door;
a leveling indicator mounted on said interior shelf; and
a plurality of feet mounted to said cabinet for support of said cabinet.

7. A laboratory incubator according to claim 6, wherein said leveling indicator indicates deviations from level around 360 degrees.

8. A laboratory incubator according to claim 7, wherein said leveling indicator is a bullseye type level.

9. A laboratory incubator according to claim 6, wherein said feet are independently adjustable to adjust the level of said cabinet.

10. A laboratory incubator according to claim 8, wherein said leveling indicator is mounted in a front portion of said shelf, adjacent to said door.

11. A laboratory incubator according to claim 10, wherein said indicator is mounted on a front corner of said shelf opposite from the corner adjacent said hinge.

12. A laboratory incubator according to claim 10, wherein said indicator is mounted on a front comer of said shelf, said comer is adjacent to said hinge.

13. A laboratory incubator according to claim 8, wherein said leveling indicator is substantially flush with the top wall of said interior shelf.

14. A laboratory incubator according to claim 8, wherein said leveling indicator is flush with the top wall of said interior shelf.

15. A laboratory incubator comprising:
a cabinet;
level indicating means for indicating the level of said cabinet, said indicating means mounted to a portion of said cabinet.

16. A laboratory incubator according to claim 15, wherein said portion of said cabinet is a shelf and said indicating means is mounted to said shelf.

17. A method for leveling a laboratory incubator including a cabinet having four walls, a top wall and lower wall, the cabinet enclosing an interior incubating chamber accessible through a door, and a plurality of feet mounted to the cabinet, comprising the steps of:
reading a leveling indicator installed on a portion of the cabinet; and
adjusting the feet in response to the reading of the leveling indicator.

18. A method according to claim 17, wherein the leveling indicator is installed on a top wall of the cabinet.

19. A method according to claim 17, wherein the leveling indicator is installed on an interior shelf of the cabinet.
